(19) United States
(12) Patent Application Publication
(10) Pub. No.: US 2018/0127567 A1
(43) Pub. Date: May 10, 2018

(54) MASS TRANSIT VEHICLE COMPONENT

(71) Applicant: SABIC GLOBAL TECHNOLOGIES B.V., Bergen op Zoom (NL)

(72) Inventors: Mark Adrianus Johannes van der Mee, Breda (NL); Christianus Johannes Jacobus Maas, Zeeland (NL); Henrica Norberta Alberta Maria Steenbakkers-Menting, Geleen (NL); Roland van Giesen, Geleen (NL); Maud Corrina Willie van der Ven, Geleen (NL); Rick Robert Emilie Bercx, Geleen (NL)

(21) Appl. No.: 15/570,572

(22) PCT Filed: Apr. 29, 2016
(86) PCT No.: PCT/EP2016/059662

§ 371 Date: Oct. 30, 2017

(30) Foreign Application Priority Data
Apr. 29, 2015 (EP) 15165545.3

(51) Int. Cl. C08K 5/521; C08J 5/18; C08K 7/14; C08K 5/49; C08K 3/22; C09K 21/12; C09K 21/02; B32B 3/12; B32B 27/32; B32B 27/18; B32B 27/08

(52) U.S. Cl. CPC C08K 5/521; B32B 2307/546; C08K 7/14; C08K 5/49; C08K 3/22; C09K 21/12; C09K 21/02; B32B 3/12; B32B 27/32; B32B 27/18; B32B 27/08; C08J 2323/12; C08J 2423/12; C08K 2003/2296; C08K 2201/014; B32B 2262/101; B32B 2305/08; B32B 2323/10; B32B 2605/00; B32B 2307/3065; B32B 2307/54; C08J 5/18

(57) ABSTRACT

The invention is directed to a mass transit vehicle component, to a method for preparing a mass transit vehicle component with improved smoke density and/or heat release performance, to the use of a component in mass transit vehicles, and to a use of a pellet or composition. The mass transit vehicle component of the invention is prepared from i) pellets of a flame retardant glass fibre reinforced polypropylene composition; ii) a composition comprising: a) pellets of a fibre reinforced polypropylene composition; and b) a flame retardant polypropylene dilution composition; or iii) a composition comprising: a) pellets of a flame retardant fibre reinforced polypropylene composition, and b) a flame retardant polypropylene dilution composition.

The invention is directed to a mass transit vehicle component, to a method for preparing a mass transit vehicle component with improved smoke density and/or heat release performance, to the use of a component in mass transit vehicles, and to a use of a pellet or composition.

Driving by a growing demand by industry, governmental regulatory agencies and consumers for durable and inexpensive products that are functionally comparable or superior to metal products, a continuing need exists for improvements in composite articles subjected to difficult service conditions. While synthetic polymers, for example, have numerous advantages, there is one obvious disadvantage related to the high flammability of many synthetic polymers. Fire hazard is a combination of factors, including ignitability, ease of extinction, flammability of the volatile products generated, amount of heat released on burning, rate of heat release, flame spread, smoke obscuration, and smoke toxicity, as well as the fire scenario. It is clear that flame retardants are an important part of polymer formulations for applications where fast spread of a fire may cause serious problems (associated with building materials and transportation) when evacuating people.

Accordingly, standards for flame retardancy properties such a flame spread, heat release, and smoke generation upon burning have become increasingly stringent, particularly in applications used in mass transportation (aircraft, trains, and ships), as well as building and construction. For example, the European Union has approved the introduction of a new harmonised fire standard for rail applications, namely EN-45545, to replace all currently active different standards in each member state. This standard will impose stringent requirements on heat release and smoke density properties allowed for materials used in these applications. Smoke density (Ds-4) in EN-45545 is the smoke density after four minutes determined in accordance with ISO 5659-2, heat release in EN-45545 is the maximum average rate of heat emission (MAHRE) determined in accordance with ISO 5660-1, and flame spread in EN-45545 is the critical heat flux at extinguishment (FE) measured according to ISO 5658-2.

“Hazard levels” (HL1 to HL3) have been designated, reflecting the degree of probability of personal injury as the result of a fire. The levels are based on dwell time and are related to operation and design categories. HL1 is the lowest hazard level and is typically applicable to vehicles that run under relatively safe conditions (easy evacuation of the vehicle). HL3 is the highest hazard level and represents most dangerous operation/design categories (difficult and/or time-consuming evacuation of the vehicle, e.g. in underground rail cars). For each application type, different test requirements for the hazard levels are defined. Different application types are categorised. Some examples of these categorised applications include R1 applications (interior components such as ceilings and side walls), R4 applications (lighting applications), R6 applications (back shell and base shell of passenger seats), and R22 applications (electro-technical applications and connectors).

Typical applications falling under R1 applications include interior vertical surfaces, such as side walls, front walls, end walls, partitions, room dividers, flaps, boxes, hoods and louvres, interior doors and linings for internal and external doors, window insulations, kitchen interior surfaces, interior horizontal surfaces (such as ceiling panelling), luggage storage areas (such as overhead and vertical luggage racks, luggage containers and compartments), driver's desk applications (such as panelling and surfaces of driver's desk), interior surfaces of gangways (such as interior sealants and gaskets), (folding) tables with downward facing surface, interior and exterior surface of air ducts, and devices for passenger information (such as information display screens). For R1 applications, requirements on smoke density after four minutes measured according to ISO 5659-2 (Ds-4) are Ds-4 values at or below 300 measured at 50 kW/m² for HL2 and at or below 150 measured at 50 kW/m² for HL3. Requirements on the maximum average rate of heat emission (MAHRE) measured according to ISO 5660-1 are at or below 90 kW/m² determined at 50 kW/m² for HL2 and at or below 60 kW/m² determined at 50 kW/m² for HL3. Requirements on the critical heat flux at extinguishment (CFE) measured according to ISO 5658-2 are at or above 20 kW/m² for both HL2 and HL3.

For R6 applications, covering seat components, requirements on smoke density after four minutes measured according to ISO 5659-2 (Ds-4) are Ds-4 values at or below 300 measured at 50 kW/m² for HL2 and at or below 150 measured at 50 kW/m² for HL3. Requirements on the maximum average rate of heat emission (MAHRE) measured according to ISO 5660-1 are at or below 90 kW/m² determined at 50 kW/m² for HL2 and at or below 60 kW/m² determined at 50 kW/m² for HL3. For R6 applications, no requirements on flame spread measured according to ISO 5658-2 exist.

Some flame-resistant fibre-reinforced polymer composites have been described in the art. For example, WO-A-2015/051060 describes fibre reinforced polymer composite compositions and products for automotive.

It is a challenge to develop materials that meet stringent smoke density standards and heat release standards in addition to other material requirements. It is particularly challenging to develop materials that meet these standards and that have good mechanical properties (especially impact resistance and scratch resistance) and processability. Accordingly, there remains a need for thermoplastic compositions that have a combination of low smoke and low heat release properties. Additionally, it would be desirable if compositions could be given low smoke and low heat release properties without a significant detrimental effect on one or more of material cost, processability, and mechanical properties. It would be a further advantage is the materials could be readily thermoformed or injection moulded. Furthermore, it would be desirable if such materials were in compliance with European Railway standard EN-45545, for example.

An objective of the invention is to provide a mass transit vehicle component that has excellent smoke density and heat release properties, in particular in combination with desirable mechanical properties.

The inventors surprisingly found that this objective can be met by a mass transit vehicle component that is prepared from a specific fibre filled polypropylene composition.

Accordingly, in a first aspect the invention is directed to a mass transit vehicle component, said component being prepared from
i) pellets of a flame retardant fibre reinforced polypropylene composition having a core comprising fibres and a sheath of a polypropylene compound comprising polypropylene, optional additives and a flame retardant composition and surrounding said core, wherein the flame retardant composition comprises a mixture of an organo-phosphorous compound, an organic phosphoric acid compound, and zinc oxide; and
ii) a composition comprising:
   a) pellets of a fibre reinforced polypropylene composition having a core comprising fibres and a sheath of a first polypropylene compound surrounding said core, wherein the fibre reinforced polypropylene composition comprises 10-70% by total weight of the fibre reinforced polypropylene composition of fibres and 30-90% by total weight of the fibre reinforced polypropylene composition of polypropylene compound, which polypropylene compound comprises polypropylene and optional additives said fibre reinforced polypropylene composition not containing a flame retardant composition, and
   b) a flame retardant polypropylene dilution composition comprising a second polypropylene compound containing polypropylene, optional additives and a flame retardant composition comprising a mixture of an organo-phosphorous compound, an organic phosphoric acid compound and zinc oxide, or
iii) a composition comprising:
   a) pellets of a flame retardant fibre reinforced polypropylene composition having a core comprising fibres and a sheath of a polypropylene compound comprising polypropylene, optional additives and a flame retardant composition and surrounding said core, wherein the flame retardant composition comprises a mixture of an organo-phosphorous compound, an organic phosphoric acid compound and zinc oxide, and
   b) a flame retardant polypropylene dilution composition comprising a second polypropylene compound containing polypropylene, optional additives and a flame retardant composition comprising a mixture of an organo-phosphorous compound, an organic phosphoric acid compound and zinc oxide.
      In a preferred embodiment, the invention relates to a mass transit vehicle component, wherein the pellets of a flame retardant fibre reinforced polypropylene composition i) and/or the pellets of fibre reinforced polypropylene composition ii)a) and/or the pellets of fibre reinforced polypropylene composition iii) comply with

FR>0.235*GF+15
wherein FR stands for the amount of flame retardant composition in wt % based on the total flame retardant fibre reinforced polypropylene composition,
wherein GF stands for the amount of glass fibres in wt % based on the total flame retardant fibre reinforced polypropylene composition, and wherein the total of polypropylene with optional additives (in wt %) and of flame retardant (in wt %) and the amount of glass fibres (in wt %) is 100 wt % based on the flame retardant fibre reinforced polypropylene composition.
   In a further preferred embodiment, the invention relates to a mass transit vehicle component, wherein the pellets of a flame retardant fibre reinforced polypropylene composition i) and/or the pellets of fibre reinforced polypropylene composition ii)a) and/or the pellets of the fibre reinforced polypropylene composition iii) comply with

FR>0.20*GF+19
wherein FR stands for the amount of flame retardant composition in wt % based on the total flame retardant fibre reinforced polypropylene composition,
wherein GF stands for the amount of glass fibres in wt % based on the total flame retardant fibre reinforced polypropylene composition, and wherein the total of polypropylene with optional additives (in wt %) and of flame retardant (in wt %) and the amount of glass fibres (in wt %) is 100 wt % based on the flame retardant fibre reinforced polypropylene composition.

### i) Flame Retardant Fibre Reinforced Polypropylene Composition

In a first option, the mass transit vehicle component is obtainable by using pellets of a flame retardant fibre reinforced polypropylene composition.

In a preferred embodiment, the pellets of the flame retardant fibre reinforced polypropylene composition comprises
25-80% by total weight of the composition of polypropylene with optional additives,
10-40% by total weight of the composition of fibres, and/or
10-35% by total weight of the composition of a flame retardant composition, wherein the total of polypropylene with optional additives (in wt %) and of flame retardant (in wt %) and the amount of glass fibres (in wt %) is 100 wt % based on the flame retardant fibre reinforced polypropylene composition.

The polypropylene compound of the sheath comprises at least polypropylene and a flame retardant composition.

The polypropylene can be a propylene homopolymer, a propylene-α-olefin copolymer, such as a propylene-ethylene random copolymer, an impact propylene copolymer, sometimes referred to as a heterophasic propylene copolymer, or a propylene block-copolymer. Mixtures of more than one polypropylene are also possible. Which type of polypropylene is used depends on the intended application. It is preferred to use either a polypropylene homopolymer for applications requiring high stiffness or a heterophasic propylene copolymer for applications that require good stiffness in combination with good impact properties.

The polypropylene compound typically has a melt flow index (MFI) that is significantly lower as compared to polypropylene compounds used in pultrusion processes. As such the melt flow index of the polypropylene compound may be 5-100 g/10 min (as measured at 230° C. under 2.16 kg force according to ISO 1133), preferably 10-100 g/10 min, more preferably 10-80 g/10 min, such as 20-80 g/10 min. In an embodiment, a polypropylene compound having a relatively low melt flow index such as 5-50 g/10 min or 10-50 g/10 min is used. Low melt flow index polypropylene materials intrinsically have improved mechanical properties over high melt flow index polypropylene materials.

The polypropylene can be a non-rheology controlled or non-visbroken polypropylene.

Preferably, the polypropylene compound further comprises a flame retardant composition comprising a mixture of an organo-phosphorous compound, an organic phosphoric acid compound, zinc oxide, and optionally a nitrogen-containing compound. For the avoidance of doubt the flame retardant composition is a halogen-free flame retardant composition.

In such mixture, the weight ratio of organo-phosphorous compound to phosphoric acid compound typically ranges from 1:0.01 to 1:3. Preferably, the weight ratio ranges from 1:0.5 to 1:2.5, such as from 1:1 to 1:2.

Suitable organo-phosphorous compounds that may be used in the mixture include organic phosphate compounds such as piperazine pyrophosphate, piperazine polyphosphate and combinations thereof.

Suitable phosphoric acid compounds that may be used in the mixture include phosphoric acid, melamine pyrophosphate, melamine polyphosphates, melamine phosphate and combinations thereof. The preferred phosphoric acid compound is melamine phosphate.

Suitable nitrogen-containing compounds include melamine, piperazine, and the like. Also combinations of nitrogen-containing compounds may be used. Some examples mentioned above for suitable organo-phosphorous compounds and phosphoric acid compounds (such as piperazine pyrophosphate, piperazine polyphosphate, melamine pyrophosphate, melamine polyphosphate, and melamine phosphate) already comprise such nitrogen-containing compound.

The zinc oxide is preferably used in an amount of 2-10% by total weight of the flame retardant fibre reinforced polypropylene composition, more preferably 3-6%.

An example of a commercially available flame retardant composition is ADK STAB FP-2200, available from Adeka Palmarole.

Flame retardancy can be tested using the UL-94 standard, which is the commonly accepted Standard for Safety of Flammability of Plastic Materials for Parts in Devices and Appliances testing. In this standard, vertical ratings, V2, V1 and V0 indicate that the material was tested in a vertical position and self-extinguished within a specified time after the ignition source was removed. The vertical ratings also indicate whether the test specimen dripped flaming particles that ignited a cotton indicator located below the sample. The amount of flame retardant composition can be 10-35% by total weight of the flame retardant fibre reinforced polypropylene composition. Higher amounts, such as from 20-35% may be required for applications that need to be compliant with a UL-94 5V rating. For UL—94 V0 ratings lower amounts may suffice.

The polypropylene compound may comprise additives such as antioxidants, ultraviolet stabilisers, pigments, dyes, adhesion promoters (such as modified polypropylene, in particular maleated polypropylene), antistatic agents, mould release agents, nucleating agents and the like. Usually, the amount of such additives is at most 5% by total weight of the flame retardant fibre reinforced polypropylene composition (i.e. the pellets), for example at most 4 wt %, for example at most 3 wt %, for example at most 2 wt %, for example at most 1 wt % based on the total flame retardant fibre reinforced polypropylene composition.

For the avoidance of doubt it should be understood that the term “sheath” is to be considered as a layer that tightly accommodates the core and, which is preferably in direct contact with the core.

The (pellets of) flame retardant fibre reinforced polypropylene composition, i.e. option i), preferably comprises 10-40% by total weight of the flame retardant fibre reinforced polypropylene composition of fibres, more preferably 15-40%, such as 20-35%.

The fibres used in the composition can suitably be glass fibres (including long glass fibres, short glass fibres, and chopped glass fibres), basalt fibres (including continuous basalt fibres), wollastonite fibres, ceramic fibres, slag wool fibres, stone wool fibres, and processed mineral fibres from mineral wool, or any combination thereof. Preferably, the fibres used in the composition are glass fibres.

The fibres (such as glass fibres) can have a diameter in the range of 5-50 μm, preferably 10-30 μm, such as 15-25 μm. A thinner fibre generally leads to higher aspect ratio (length over diameter ratio) of the fibres in the final product prepared from the fibre reinforced composition, yet thinner fibres may be more difficult to manufacture and/or handle.

In an embodiment, glass fibres are used that originate from glass multifibre strands, also referred to as glass rovings. Such glass multifibre strand(s) or rovings preferably comprise 500-10 000 glass filaments per strand, more preferably 2000-5000 glass filaments per strand. The linear density of the glass multifibre strand preferably is 1000-5000 tex, corresponding to 1000-5000 grams per 1000 meter. Preferably, the linear density is from 1000-3000 tex. Usually, the glass fibres are circular in cross section meaning the thickness as defined above would mean diameter. Rovings are generally available and well known to the skilled person. Examples of suitable commercially available rovings are the Advantex products designated for example as SE4220, SE4230 or SE4535 and available from Binani 3B Fibre Glass company, available as 1200 or 2400 tex, or TUFRov 4575, TUFRov 4588 available from PPG Fibre Glass. Most preferably rovings are used having a linear density of 3000 tex. These commercially available rovings contain glass fibres having a small amount of sizing composition applied thereon; typically the amount of such sizing is less than 2% by total weight of the fibres.

The pellets of the composition preferably have a length of 5-40 mm, such as 8-20 mm, and preferably 10-18 mm. The skilled person will understand that pellets preferably are substantially cylindrical with a circular cross section, yet other cross sectional shapes, like for example oval or (rounded) square are also possible and fall within the scope of the invention.

The fibres (such as glass fibres) can have an average length, which is approximately the same as the length of the pellets. Hence, the average length of the fibres can be in the range of 5-40 mm, such as in the range of 8-20, and preferably 10-18 mm. More in particular, in the pellets, the fibres generally extend in the longitudinal direction as a result of which they lie substantially in parallel to one another. Typically, the fibres extending in a longitudinal direction have a length of between 95% and 105%, more in particular between 99% and 101% of the length of a pellet. Ideally, the length of the fibres is substantially the same as the length of the pellet, yet due to some misalignment, twisting, or process inaccuracies the length may vary within the aforementioned range. In case of glass fibres, such glass fibres are generally classified as long glass fibres.

The pellets have a core-sheath structure wherein the core comprises the fibres and the sheath is comprised of the polypropylene compound. It is preferred that the core is essentially free from polypropylene compound.

The pellets can be manufactured with the wire-coating process as described in WO-A-2009/080821, the complete content of which is herewith incorporated by reference. This wire-coating process comprises the subsequent steps of:
a) unwinding from a package of at least one continuous glass multifilament strand containing at most 2% by mass of a sizing composition;
b) applying 0.5-20% by mass of an impregnating agent to the at least one continuous glass multifilament strand to form an impregnated continuous multifilament strand; and
c) applying a sheath of thermoplastic polymer around the impregnated continuous multifilament strand to form a sheathed continuous multifilament strand;
   wherein the impregnating agent is non-volatile, has a melting point of at least 20° C. below the melting point of the thermoplastic matrix, has a viscosity of 2.5-100 cS at application temperature, and is compatible with the thermoplastic polymer to be reinforced.

The sheathed continuous glass multifilament strand may then be cut into pellets of suitable length, such as a length of 2-50 mm. The pellets can be used directly in a downstream conversion process such as injection moulding. To allow a proper dispersion of the glass fibres in such downstream conversion processes the core of the pellets not only contains the glass fibres but also what is referred to as the impregnating agent. The impregnating agent facilitates a proper dispersion of the glass fibres during the moulding of the (semi) finished article. The impregnating agent is an important component of these glass fibre reinforced polyolefin materials.

In effect the impregnating agent has at least two key functions, the first one being to effectively couple the glass fibres to each other and to the polyolefin sheath in the pellet and the second one being to provide a sufficient dispersion of the glass fibres in downstream conversion processes.

Another process to manufacture glass fibre reinforced polypropylene materials is based on what is known as a pultrusion process. In such a process continuous glass multifibre strands are pulled through a molten resin in such a manner that the individual filaments are fully dispersed into the resin. Examples of such processes are disclosed in EP-A-1 364 760, NL-A-1 010 646 and WO-A-2008/089963.

An important difference between pellets obtained by the wire-coating process and pellets obtained by the pultrusion process is that the glass fibres obtained by the wire-coating process are not dispersed in the polypropylene. This dispersion will only take place once the pellets are moulded into finished or semi-finished parts in downstream conversion processes. A further difference between the pultrusion process and the wire-coating is that the pultrusion process can only run at a relatively low speed, such as in the order of 30 m/min. To the contrary the wire coating process can run at line speeds of 100 m/min or more, or even 300 m/min or more.

The polypropylene composition preferably comprises an impregnating agent. The amount of impregnating agent may vary and is preferably 0.5-7% by total weight of the flame retardant fibre reinforced polypropylene composition. The amount of impregnating agent may also be expressed relative to the weight of the fibres. Preferably, the amount of impregnating agent is 5-15% by total weight of the fibres, more preferably 7-15%.

The presence of an impregnating agent allows a good dispersion of the fibres within the polypropylene composition during downstream conversion processes, such as for example injection moulding. In addition to that the impregnating agent also couples the fibres to each other and to the sheath to a certain extent.

It is preferred to use an impregnating agent as defined in WO-A-2009/080821. That is, preferably the impregnating agent is non-volatile, has a melting point of at least about 20° C. below the melting point of the polypropylene compound sheath and has a viscosity of 2.5-100 cS at application temperature.

The viscosity of the impregnating agent can be 100 cS or less, preferably 75 cS or less, and more preferably 25 cS or less at application temperature. The viscosity of the impregnating agent can be 2.5 cS or more, preferably 5 cS or more, and more preferably 7 cS or more at the application temperature. An impregnating agent having a viscosity of more than 100 cS is difficult to apply to a continuous strand of glass fibres. Low viscosity is needed to facilitate good wetting performance of the glass fibres, but an impregnating agent having a viscosity of less than 2.5 cS is difficult to handle, e.g., the amount to be applied is difficult to control.

The melting temperature of the impregnating agent can be at least about 20° C., preferably at least 25° C. or at least 30° C. below the melting point of the polypropylene composition sheath. The application temperature of the impregnating agent is suitably selected such that the desired viscosity range is obtained.

The amount of impregnating agent that is applied depends inter alia on the thermoplastic polymer used for the sheath, the amount of fibres, the size (diameter) of the fibres, and on the type of sizing that is on the surface of the fibres. The amount of impregnating agent applied to the fibres is preferably 0.5% or more by total weight of the fibres (including the sizing composition), more preferably 2% or more, even more preferably 4% or more, and most preferably 6% or more. The amount of impregnating agent is typically 20% or less by total weight of the fibres (including the sizing composition), preferably 18% or less, more preferably 15% or less, and even more preferably 12% or less. In general, a higher amount of fibres requires a higher amount of impregnating agent. A certain minimum amount of impregnating agent is desired to assist homogeneous dispersion of fibres in the thermoplastic polymer matrix during moulding. An excess of impregnating agent may result in decrease of mechanical properties of the moulded articles.

Suitable examples of impregnating agents for use in combination with polypropylene as the material for the sheath may comprise highly branched poly(α-olefins), such as polyethylene waxes, modified low molecular weight polypropylenes, mineral oils, such as, paraffin or silicon and any mixtures of these compounds. Preferably, the impregnating agent comprises a highly branched poly(α-olefin) and, more preferably, the impregnating agent is a highly branched polyethylene wax. The wax may optionally be mixed with a hydrocarbon oil or wax like a paraffin oil to reach the desired viscosity. WO-A-2009/080281 discloses as an exemplary impregnating agent a blend of 30 wt. % of Vybar 260 (hyper branched polymer supplied by Baker Petrolite) and 70 wt. % of Paralux oil (paraffin, supplied by Chevron). The term non-volatile means that the impregnating agent does not evaporate under the application and processing conditions applied. In the context of the present application, “substantially solvent-free” means that the impregnating agent contains 10% or less by mass of solvent, preferably 5% or less by mass of solvent. Most preferably, the impregnating agent is free of any solvent. The impregnating agent may further be mixed with other additives known in the art.

In a more preferred embodiment, the impregnating agent comprises 70% or more by total weight of the impregnating agent of microcrystalline wax. In that respect it is to be understood that the microcrystalline wax may be a single microcrystalline wax or a blend of several microcrystalline waxes. Microcrystalline waxes are known materials. In general a microcrystalline wax is a refined mixture of solid saturated aliphatic hydrocarbons, and produced by de-oiling certain fractions from the petroleum refining process. Microcrystalline waxes differ from refined paraffin wax in that the molecular structure is more branched and the hydrocarbon chains are longer (higher molecular weight). As a result the crystal structure of microcrystalline wax is much finer than paraffin wax, which directly impacts many of the mechanical properties of such materials. Microcrystalline waxes are tougher, more flexible and generally higher in melting point compared to paraffin wax. The fine crystalline structure also enables microcrystalline wax to bind solvents or oil and thus prevents the sweating out of compositions. Microcrystalline wax may be used to modify the crystalline properties of paraffin wax. Microcrystalline waxes are also very different from so-called iso-polymers. First of all, microcrystalline waxes are petroleum based whereas iso-polymers are poly-α-olefins. Secondly iso-polymers have a very high degree of branching of above 95%, whereas the amount of branching for microcrystalline waxes generally lies in the range of 40-80 wt. %. Finally, the melting point of iso-polymers generally is relatively low compared to the melting temperature of microcrystalline waxes. All in all, microcrystalline waxes form a distinct class of materials not to be confused either by paraffin or by iso-polymers.

The remaining 30% or less by total weight of the impregnating agent may comprise a natural or synthetic wax or an iso-polymer. Typical natural waxes are animal waxes such as bees wax, lanolin and tallow, vegetable waxes such as carnauba, candelilla, soy, mineral waxes such as paraffin, ceresin and montan. Typical synthetic waxes include ethylenic polymers such as polyethylene wax or polyol ether-ester waxes, chlorinated naphthalenes and Fisher-Tropsch derived waxes. A typical example of an iso-polymer, or hyper-branched polymer, is Vybar 260 mentioned above. In an embodiment, the remaining 30% or less by total weight of the impregnating agent comprises or consists of one or more selected from a highly branched poly-α-olefin (such as a polyethylene wax) and paraffin. In a further preferred embodiment, the impregnating agent comprises at least 80% or more by total weight of the impregnating agent of microcrystalline was, more preferably 90% or more, even more preferably 95% or more, and most preferably 99% or more. It is most preferred that the impregnating agent substantially consists of microcrystalline wax. The term “substantially consists of” is to be interpreted such that the impregnating agent comprises 99.9% or more by total weight of the impregnating agent of microcrystalline wax. In an embodiment, the impregnating agent is free of paraffin.

The microcrystalline wax preferably has one or more of the following properties:
a drop melting point of 60-90° C. as determined in accordance with ASTM D127
a congealing point of 55-90° C. as determined in accordance with ASTM D938
a needle pen penetration at 25° C. of 7-40 tenths of a mm as determined in accordance with ASTM D1321
a viscosity at 100° C. of 10-25 mPa·s as determined in accordance with ASTM D445
an oil content of 0-5% by total weight of the microcrystalline wax, preferably 0-2%, as determined in accordance with ASTM D721

In an even more preferred embodiment the microcrystalline wax has all these properties in combination.

The skilled person will understand that the core of the pellet comprising the fibres and the impregnating agent will only be surrounded by the polypropylene compound sheath in the longitudinal direction. Hence, the core of the pellet is exposed to the surrounding at the two cutting planes, or cross sectional surfaces corresponding to the positions where the pellet was cut. It is for this reason that upon insufficient coupling of the fibres to the sheath the fibres may separate from the pellet.

The flame retardant fibre reinforced polypropylene composition preferably exhibits a UL-94 flame retardancy rating of V0 at 3.2 mm thickness, preferably a V0 rating at 2.0 mm thickness, most preferably a V0 rating at 1.6 mm thickness. The flame retardant fibre reinforced polypropylene composition preferably passes the UL-94 5V rating at 3.2 mm thickness, more preferably it passes the UL-94 5V rating at 2.0 mm thickness, tested on bars.

The flame retardant fibre reinforced polypropylene composition preferably exhibits a Glow Wire Flammability Index as measured according to IEC-60695-2-12 of 725° C. or more at 0.8 mm thickness.

The flame retardant fibre reinforced polypropylene composition preferably exhibits a comparative tracking index measured according to International Electrotechnical Commission standard IEC-60112/3^{rd} of 600 V or more.

In order to get a UL-94 V0 rating at 1.6 mm thickness, it was found that the amount of flame retardant material should be selected according to the following equation (1):

FR≥0.5×GF+5 (1)

wherein FR is the amount of flame retardant composition in % by total weight of the flame retardant fibre reinforced polypropylene composition, and GF is the amount of fibres in % by total weight of the flame retardant fibre reinforced polypropylene composition. The amount of fibres is preferably 10%, more preferably 15% or more by total weight of the flame retardant fibre reinforced polypropylene composition, more preferably 20-40%.
ii) Composition with Flame Retardant Free Fibre Reinforced Polypropylene Composition

In a second option, the mass transit vehicle component is obtainable by using a composition (such as a moulding composition) that comprises
a) pellets of a fibre reinforced polypropylene composition having a core containing fibres and a sheath of a first polypropylene compound surrounding said core, wherein the fibre reinforced polypropylene composition comprises 10-70% by total weight of the fibre reinforced polypropylene composition of fibres and 30-90% by total weight of the fibre reinforced polypropylene composition of polypropylene compound, said fibre reinforced polypropylene composition not containing a flame retardant composition, and
b) a flame retardant polypropylene dilution composition comprising a second polypropylene compound containing a flame retardant composition comprising a mixture of an organo-phosphorous compound, an organic phosphoric acid compound, zinc oxide, and optionally a nitrogen-containing compound.

With respect to the type of fibres, the type of first polypropylene compound, the amount and type of impregnating agent in the pellets of the fibre reinforced polypropylene composition, the description of the first option of the invention equally applies, except for the flame retardant composition which is excluded from the pellets according to the second option of the invention. Similarly, the flame retardancy, and the mechanical properties as described for the first option equally apply to the second option of the invention.

Preferably, the fibre reinforced polypropylene composition in the composition and not containing a flame retarding composition, i.e. option ii)a), comprises 15-70% by total weight of the fibre reinforced polypropylene composition of fibres, preferably 20-70%, such as 30-65%.

The flame retardant polypropylene dilution composition is preferably in the form of pellets based on a homogeneous mixture of the flame retardant composition and the second polypropylene compound.

The mixture of organo-phosphorous compound, organic phosphoric acid compound, zinc oxide, and optionally nitrogen-containing compound is as described herein above for the first option of the invention.

In a preferred embodiment, the flame retardant dilution composition consists of pellets according to first option of the invention.

The polypropylene of the second polypropylene compound may be the same or different as the polypropylene of the first polypropylene compound and is preferably the same.

The advantage of the second option of the invention is that it gives more production flexibility in that the amount of fibres as well as the amount of flame retardant in the final component manufactured from the composition can be selected without a change in the fibre reinforced composition. In other words, standard and/or existing fibre reinforced polypropylene grades can be used.

In a further preferred embodiment, the composition comprises a third polypropylene compound not containing a flame retardant composition.

The polypropylene of the third polypropylene compound may be the same or different as the first or second polypropylene. By using a third polypropylene compound a converter has the most freedom in designing an end product wherein the mechanical properties, in terms of amount of fibres, and the flame retardancy in terms of amount of flame retardant composition can be selected using more or less standard components.

The third polypropylene compound is preferably in the form of pellets and is preferably a commercially available polypropylene material.

iii) Composition with Flame Retardant Fibre Reinforced Polypropylene Composition

In a third option, the mass transit vehicle component is obtainable by using a composition (such as a moulding composition) that comprises
a) pellets of a flame retardant fibre reinforced polypropylene composition having a core containing fibres and a sheath of a polypropylene compound comprising a flame retardant composition and surrounding said core, wherein the flame retardant composition comprises a mixture of an organo-phosphorous compound, an organic phosphoric acid compound, zinc oxide, and optionally a nitrogen-containing compound, and
b) a flame retardant polypropylene dilution composition comprising a second polypropylene compound containing a flame retardant composition comprising a mixture of an organo-phosphorous compound, an organic phosphoric acid compound, zinc oxide, and optionally a nitrogen-containing compound.

In accordance with this option, the (pellets of the) flame retardant fibre reinforced polypropylene composition preferably comprises
35-80% by total weight of the composition of polypropylene compound,
10-40% by total weight of the composition of fibres, and/or
10-35% by total weight of the composition of a flame retardant composition.

In accordance with this third option, the amount of flame retardant is the same as in the first option. Hence, the amount of flame retardant composition is 10-35% by total weight of the flame retardant fibre reinforced polypropylene composition. Higher amounts, such as from 20-35% may be required for applications that need to be compliant with a UL-94 5V rating. For UL-94 V0 ratings lower amounts may suffice, depending also on the amount of glass fibres as explained herein, and on the amount of pellets of the dilution polypropylene composition.

The (pellets of) flame retardant fibre reinforced polypropylene composition according to option iii), preferably comprises 10-40% by total weight of the flame retardant fibre reinforced polypropylene composition of fibres, more preferably 15-40%, such as 20-35%.

With respect to the type of fibres, the type of polypropylene compound and the amount and type of impregnating agent in the pellets of the flame retardant fibre reinforced polypropylene composition, the description of the first and second options equally applies. Similarly, the flame retardancy, and the mechanical properties as described for the first and second options equally apply to the third option.

The mixture of organo-phosphorous compound, organic phosphoric acid compound, zinc oxide, and optionally a nitrogen-containing compound is as described herein above for the first and second option of the invention.

The term “mass transit vehicle component” as used in this application is meant to include both complete components, as well as portions of mass transit vehicle components. The mass transit vehicle components of the invention can have a wide variety of applications, particularly those requiring low smoke and low heat release values. The components can be manufactured by any suitable downstream conversion process, including foaming, moulding, thermoforming, extruding, and casting the pellets i) or compositions ii) or iii). Typical moulding methods include injection moulding, extrusion (including sheet extrusion and/or co-extrusion), rotational moulding, blow moulding and thermoforming. Thus, the component may be in the form of a foamed article, a moulded article, a thermoformed article, an extruded film, an extruded sheet, a layer of a multilayer article (e.g. a cap layer), a substrate for a coated article, or a substrate for a metallised article. Suitably, the component can be in the form of a panel, a laminate, a multilayer, a foam, or a honeycomb.

Illustrative components of the invention include access panels, access doors, air flow regulators, air gaspers, air grilles, arm rests, baggage storage doors, balcony components, cabinet walls, ceiling panels, door pulls, door handles, duct housing, enclosures for electronic devices, equipment housings, equipment panels, floor panels, food carts, food trays, galley surfaces, grilles, handles, housings for televisions and displays, light panels, magazine racks, telephone housings, partitions, parts for trolley carts, seat backs, seat components, railing components, seat housings, shelves, side walls, speaker housings, storage compartments, storage housings, toilet seats, tray tables, trays, trim panels, window mouldings, window slides, windows, and the like.

The term “mass transit vehicle” as used in this application is meant to refer to any vehicle that is configured to carry passengers and which is operated in a mass transit system, whether public or private. Preferably, the mass transit vehicle is a vehicle for public transportation. Suitable examples of mass transit vehicles include a train, a tram, a subway, a light rail, a monorail, an aircraft, a helicopter, a bus, a trolley, a ferry, a cable car, and the like.

In an embodiment, the mass transit vehicle component of the invention is not an automotive part.

The inventors found that the material used for preparing the component in accordance with the invention has exceptionally good smoke density and heat release properties, thereby allowing to meet e.g. the EN-45545 fire standard for rail applications. It is surprising that these materials have such good smoke density and heat release properties, despite the presence of the glass fibres in the materials. Additionally, it was found that these materials yield components that have excellent mechanical properties.

The component preferably exhibits a smoke density after four minutes (Ds-4) of 300 or less as measured according to ISO 5659-2 on a 3 mm thick plaque at 50 kW/m². More preferably, the component exhibits a smoke density after four minutes (Ds-4) of 200 or less, even more preferably 150 or less, such as 100 or less.

The component further preferably exhibits an integral of the smoke density as a function of time up to 4 minutes (VOF4) of 400 or less as measured according to ISO 5659-2 on a 3 mm thick plaque at 50 kW/m².

Furthermore, the component preferably has a maximum average heat release (MAHRE) of 90 kW/m² or less as measured according to ISO 5660-1 of a 3 mm thick plaque at 50 kW/m², more preferably 89 kW/m² or less, even more preferably 88 kW/m² or less, such as 87 kW/m² or less.

If the composition meets the UL-94 V0 rating, this does not necessarily mean that the component meets the more stringent requirements of smoke density after four minutes (Ds-4) of 300 or less, integral of the smoke density as a function of time up to 4 minutes (VOF4) of 400 or less, and/or a maximum average heat release (MAHRE) of 90 kW/m². The latter requirements are necessary to make the component suitable as a mass transit vehicle component.

The component preferably has a tensile modulus as measured according to ISO 527 in flow direction of 2500-8500 MPa, more preferably 300-700 MPa, such as 4000-6000 MPa, or 4500-6500 MPa. In crossflow direction, the component preferably has a tensile modulus of 1300-3800 MPa, more preferably 1500-3600 MPa, such as 1700-3400 MPa.

The component preferably has an elongation at break as measured according to ISO 527 in flow direction of 0.5-1.8%, more preferably 0.7-1.6%, such as 0.9-1.4%. In crossflow direction, the component preferably has an elongation at break of 0.8-2.1%, more preferably 1.0-1.9%, such as 1.2-1.8%.

The component preferably has a flexural modulus as measured according to ISO 178 in flow direction of 4600-7100 MPa, more preferably 4800-6900 MPa, such as 5000-6700 MPa. In crossflow direction, the component preferably has a flexural modulus of 1400-2500 MPa, preferably 1600-2400 MPa, such as 1800-2100 MPa.

In a special embodiment, the mass transit vehicle component further comprises a cap layer comprising a polypropylene, This cap layer is preferably a layer in contact with the material as described herein, and may suitably be prepared by co-extrusion together with the materials i), ii), or iii) as described herein. An example of a co-extrusion process that can typically be used to prepare multi-layer articles (comprising two or more layers) is sheet co-extrusion. The use of such a cap layer surprisingly does not negatively affect the smoke density and/or heat release performance of the component. Advantageously, such a cap layer improves the aesthetics (including gloss, surface finish and colour) of the component and moreover improves the chemical resistance to cleaning agents (such as cleaning agents used for the removal of graffiti).

The additional cap layer comprising random polypropylene copolymer can have a typical thickness in the range of 10-1000 μm, such as 10-800 μm, or 20-600 μm.

The cap layer can comprises one or more selected from the group consisting of a propylene homopolymer, a random polypropylene copolymer formed with α-olefins, and an impact polypropylene copolymer with a discrete rubber phase based on ethylene or propylene copolymer elastomers. Preferably, the cap layer comprises at least a random polypropylene copolymer. More preferably, the cap layer essentially consists of random polypropylene copolymer.

The cap layer may have a thickness of 700 μm or less, such as 10-650 μm or 20-600 μm.

In accordance with this embodiment where the additional cap layer is present, the component preferably has a tensile modulus as measured according to ISO 527 in flow direction of 2000-3500 MPa, more preferably 2200-3300 MPa, such as 2000-3100 MPa. In crossflow direction, the component preferably has a tensile modulus of 1400-2200 MPa, more preferably 1600-2000 MPa, such as 1700-1900 MPa.

In this embodiment where the cap layer is present, the component preferably has an elongation at break as measured according to ISO 527 in flow direction of 0.9-2.7%, more preferably 1.1-2.5%, such as 1.3-2.3%. In crossflow direction, the component preferably has an elongation at break of 1.9-2.7%, more preferably 2.0-2.6%, such as 2.1-2.5%.

In this embodiment where the cap layer is present, the component preferably has a flexural modulus as measured according to ISO 178 in flow direction of 2200-3500 MPa, more preferably 2400-3300 MPa, such as 2600-3100 MPa. In crossflow direction, the component preferably has a flexural modulus of 1000-1700 MPa, preferably 1200-1600 MPa, such as 1300-1500 MPa.

In a further aspect, the invention is directed to a method for preparing a mass transit vehicle component with improved smoke density and/or heat release performance, said method comprising moulding and/or extruding a component from a pellet or moulding composition as defined herein. The improved smoke density performance refers to a smoke density after four minutes (Ds-4) of 300 or less as measured according to ISO 5659-2 on a 3 mm thick plaque at 50 kW/m², preferably 200 or less, more preferably 150 or less, such as 100 or less. The improved heat release performance refers to a maximum average heat release (MAHRE) of 90 kW/m² or less as measured according to ISO 5660-1 of a 3 mm thick plaque at 50 kW/m², preferably 89 kW/m² or less, more preferably 88 kW/m² or less, such as 87 kW/m² or less.

The moulding and/or extruding can, for instance, be effected by conventional injection moulding, blow moulding, compression moulding, roto-moulding, stretch blow moulding, slush-moulding, thermoforming, or extrusion (including sheet or film extrusion, pipe extrusion and cable extrusion). Such processes are well-known in the art.

In yet a further aspect, the invention is directed to the use of a pellet or moulding composition as described herein in a mass transit vehicle component. The components as described herein have surprisingly good smoke density and heat release properties. These surprising properties make the components highly suitable for use in mass transit vehicle, where stringent requirements are set on the components used so as to provide passengers with the highest practical degree of safety.

In yet a further aspect, the invention is directed to the use of a pellet or moulding composition as defined herein, for decreasing the smoke density and/or heat release of a component for a mass transit vehicle.

The excellent properties of the material can advantageously be used to decrease the smoke density and/or heat release of a component for a mass transit vehicle.

Apart from the cap layer, the component may additionally comprise a decoration layer that can be laminated on the component. A decoration layer is a layer for adding a decoration of a colour, a pattern, a wood-effect, a metallic appearance, a pearly appearance or the like.

All references cited herein are hereby completely incorporated by reference to the same extent as if each reference were individually and specifically indicated to be incorporated by reference and were set forth in its entirety herein.

The use of the terms “a” and “an” and “the” and similar referents in the context of describing the invention (especially in the context of the claims) are to be construed to cover both the singular and the plural, unless otherwise indicated herein or clearly contradicted by context. The terms “comprising”, “having”, “including” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. For the purpose of the description and of the appended claims, except where otherwise indicated, all numbers expressing amounts, quantities, percentages, and so forth, are to be understood as being modified in all instances by the term “about”. Also, all ranges include any combination of the maximum and minimum points disclosed and include and intermediate ranges therein, which may or may not be specifically enumerated herein.

Preferred embodiments of this invention are described herein. Variation of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject-matter recited in the claims appended hereto as permitted by applicable law. Moreover, any combination of the above-described elements in all possible variations thereof is encompassed by the invention unless otherwise indicated herein or otherwise clearly contradicted by context. The claims are to be construed to include alternative embodiments to the extent permitted by the prior art.

For the purpose of clarity and a concise description features are described herein as part of the same or separate embodiments, however, it will be appreciated that the scope of the invention may include embodiments having combinations of all or some of the features described.

The invention will now be further illustrated by the following non-limiting examples.

### EXAMPLES

Test components were prepared by sheet extruding compositions as shown in table 1. The cap layer used for inventive composition 2 was applied by co-extrusion.

TABLE 1
Sample Compositions and properties of test components

| | | Inventive | Inventive | Comparative |
|---|---|---|---|---|
| | | composition | composition | composition |
| Component | Supplier | 1 (wt. %) | 2 (wt. %) | (wt. %) |
| polypropylene | Sabic | 45 | 45 | 70 |
| copolymer | | | | |
| glass fibres | 3B Fibre | 30 | 30 | 30 |
| | Glass | | | |
| | Company | | | |
| ADK STAB | Adeka | 25 | 25 | 0 |
| FP-2200 | | | | |
| flame retardant | | | | |
| composition | | | | |
| Random | Sabic | — | 30-500 μm | — |
| polypropylene | | | | |
| cap layer | | | | |
| Smoke Ds-4 | | 40 | 33 | 460 |
| ISO 5659-2 | | | | |
| Spec <300 | | | | |
| Heat release | | 73 | 76 | 280 |
| MAHRE ISO | | | | |
| 5660-1 Spec <90 | | | | |

Smoke density and heat release tests were performed on test components that were prepared by moulding the sample compositions as shown in table 1.

Smoke density measurements were performed on 7.5×7.5 cm plaques with 3 mm thickness using an NBS Smoke Density Chamber from Fire Testing Technology Ltd (West Sussex, United Kingdom). All measurements were performed according to ISO 5659-2, with an irradiance of 50 kW/m² at the sample position and a sample-to-cone distance of 5 cm in view of the charring behaviour of the samples (as prescribed by ISO 5659-2). Ds-4 was determined as the measured smoke density after 240 s.

Heat release measurements were performed on 10×10 cm plaques with 3 mm thickness using a Cone calorimeter. All measurements were performed according to ISO 5660-1, with 50 kW/m² irradiance at the sample position and a sample-to-cone distance of 6 cm in view of the charring behaviour of the samples (as prescribed by ISO 5660-1). Heat release is measured as MAHRE in kW/m² as prescribed by ISO 5660-1.

Graffiti cleaning resistance of a multilayer sheet prepared from inventive composition 2 was tested according to ASTM D6578-08. The initial colour of the sheet is measured. The sheet is divided in separate zones for each cleaning agent. Red alkyd paint spray was applied on the different zones. The sample was stored at least 24 hours before each zone was cleaned with one of the cleaning agents listed in the table below. A cotton cloth wetted with a cleaning agent was used to remove a marked zone. The area of the cotton cloth that is wetted was well saturated but not dripping. Each marking was vigorously rubbed until it was completely cleaned of or until it was visually evident that no more of the mark could be removed. For each cleaning agent, a different cloth was used.

After the graffiti had been applied and removed, the colour was measured in the area where the graffiti was applied. The ΔE CIE Lab based on comparison of the average colour coordinates for the surface prior to application of the graffiti was calculated. For a graffiti marking to be considered as completely removed, the ΔE should be less than 2.

The values presented in table 2 are the average of at least four measurements. The surface of the material being not perfectly homogeneous in terms of colour, the initial relative error on ΔE was calculated. This error was intrinsic to the material and was taken into account.

TABLE 2
Graffiti cleaning resistance results

| Reflection mode | | | | |
|---|---|---|---|---|
| Illuminant D65 | | | | |
| Observer 10 D | L* | a* | b* | ΔE |
| Initial values | 30.03 | 0.08 | −1.60 | Initial |
| Standard deviation | 0.78 | 0.02 | 0.12 | relative |
| | | | | error on ΔE: |
| | | | | 0.79 |
| Ecoatex Plus | 31.29 | 0.36 | −0.93 | 1.46 |
| Standard deviation | 0.35 | 0.02 | 0.06 | |
| Natuflex D | 3.65 | 0.06 | −0.56 | 1.21 |
| Standard deviation | 0.24 | 0.06 | 0.23 | |
| Remosolv | 30.56 | 0.39 | −1.17 | 0.76 |
| Standard deviation | 0.05 | 0.03 | 0.04 | |

In Table 3, the relation between the amount of glass fibres and the amount of flame retardant composition in the flame retardant fibre reinforced polypropylene composition and the performance of the flame retardant fibre reinforced polypropylene composition in a MAHRE test, hazard level 2 or 3 (HL2 or HL3) (as performed as described above) is given. The flame retardant composition comprises an amount of polypropylene such that the sum of the polypropylene (in wt %), the amount of flame retardant composition (in wt %) and the amount of glass fibres (in wt %) equals 100 wt %.

TABLE 3

| | | | Minimal |
|---|---|---|---|
| | | | amount |
| | Minimal amount of | Minimal amount of | of ADK STAB |
| | ADK STAB FP-2200 | ADK STAB FP-2200 | FP-2200 flame |
| | flame retardant | flame retardant | retardant |
| Glass | composition (wt %) | composition (wt %) | composition |
| fibres | to reach MAHRE | to reach MAHRE | (wt %) to |
| (wt %) | HL2 (<90 kW/m2) | HL3 (<60 kW/m2) | reach UL94 V0 |
| 10 | 17 | 21 | 14.6 |
| 15 | 18.5 | 22 | |
| 20 | 20 | 23 | |
| 30 | 22.5 | 25 | 15 |
| 40 | 24 | 27 | |

As can be seen from Table 3 above, a composition which reaches UL94 V0 does not necessarily meet the HL2 or HL3 of the MAHRE test.
As can be derived from Table 3, preferably in the flame retardant composition

FR>0.235*GF+15
wherein FR stands for the amount of flame retardant composition in wt % based on the total flame retardant fibre reinforced polypropylene composition,
wherein GF stands for the amount of glass fibres in wt % based on the total flame retardant fibre reinforced polypropylene composition, and wherein the total of polypropylene with optional additives (in wt %) and of flame retardant (in wt %) and the amount of glass fibres (in wt %) is 100 wt % based on the flame retardant fibre reinforced polypropylene composition.
   Such composition meets MAHRE HL2.
   More preferably, in the flame retardant composition

FR>0.20*GF+19
wherein FR stands for the amount of flame retardant composition in wt % based on the total flame retardant fibre reinforced polypropylene composition,
wherein GF stands for the amount of glass fibres in wt % based on the total flame retardant fibre reinforced polypropylene composition, and wherein the total of polypropylene with optional additives (in wt %) and of flame retardant (in wt %) and the amount of glass fibres (in wt %) is 100 wt % based on the flame retardant fibre reinforced polypropylene composition.
   Such composition meets MAHRE HL3.
   In a preferred embodiment, the amount of glass fibres is at least 10 wt % based on the total flame retardant fibre reinforced polypropylene composition.

1. Mass transit vehicle component, said component being prepared from
i) pellets of a flame retardant fibre reinforced polypropylene composition having a core comprising fibres and a sheath of a polypropylene compound comprising polypropylene, optional additives and a flame retardant composition and surrounding said core, wherein the flame retardant composition comprises a mixture of an organo-phosphorous compound, an organic phosphoric acid compound and zinc oxide;
ii) a composition comprising:
a) pellets of a fibre reinforced polypropylene composition having a core comprising fibres and a sheath of a first polypropylene compound, which polypropylene compound comprises polypropylene and optional additives surrounding said core, wherein the fibre reinforced polypropylene composition comprises 10-70% by total weight of the fibre reinforced polypropylene composition of fibres and 30-90% by total weight of the fibre reinforced polypropylene composition of polypropylene compound, said fibre reinforced polypropylene composition not containing a flame retardant composition, and
b) a flame retardant polypropylene dilution composition comprising a second polypropylene compound containing polypropylene, optional additives and a flame retardant composition comprising a mixture of an organo-phosphorous compound, an organic phosphoric acid compound and zinc oxide; or
iii) a composition comprising:
a) pellets of a flame retardant fibre reinforced polypropylene composition having a core comprising fibres and a sheath of a polypropylene compound comprising polypropylene, optional additives and a flame retardant composition and surrounding said core, wherein the flame retardant composition comprises a mixture of an organo-phosphorous compound, an organic phosphoric acid compound and zinc oxide, and
b) a flame retardant polypropylene dilution composition comprising a second polypropylene compound containing polypropylene, optional additives and a flame retardant composition comprising a mixture of an organo-phosphorous compound, an organic phosphoric acid compound and zinc oxide.

2. Mass transit vehicle component according to claim 1, wherein the pellets of a flame retardant fibre reinforced polypropylene composition i) and/or the pellets of fibre reinforced polypropylene composition ii)a) and/or the pellets of fibre reinforced polypropylene composition iii) comply with
FR>0.235*GF+15
wherein FR stands for the amount of flame retardant composition in wt % based on the total flame retardant fibre reinforced polypropylene composition,
wherein GF stands for the amount of glass fibres in wt % based on the total flame retardant fibre reinforced polypropylene composition,
and wherein the total of polypropylene with optional additives (in wt %) and of flame retardant (in wt %) and the amount of glass fibres (in wt %) is 100 wt % based on the flame retardant fibre reinforced polypropylene composition.

3. Mass transit vehicle component according to claim 1, wherein the pellets of a flame retardant fibre reinforced polypropylene composition i) and/or the pellets of fibre reinforced polypropylene composition ii)a) and/or the pellets of the fibre reinforced polypropylene composition iii) comply with
FR>0.20*GF+19
wherein FR stands for the amount of flame retardant composition in wt % based on the total flame retardant fibre reinforced polypropylene composition,
wherein GF stands for the amount of glass fibres in wt % based on the total flame retardant fibre reinforced polypropylene composition,
and wherein the total of polypropylene with optional additives (in wt %) and of flame retardant (in wt %) and the amount of glass fibres (in wt %) is 100 wt % based on the flame retardant fibre reinforced polypropylene composition.

4. Mass transit vehicle component according to claim 1, wherein the pellets of a flame retardant fibre reinforced polypropylene composition i) comprise
25-80% by total weight of the composition of polypropylene with optional additives,
10-40% by total weight of the composition of fibres, and/or
10-35% by total weight of the composition of a flame retardant composition,
wherein the total of polypropylene with optional additives (in wt %) and of flame retardant (in wt %) and the amount of glass fibres (in wt %) is 100 wt % based on the flame retardant fibre reinforced polypropylene composition.

5. Mass transit vehicle component according to claim 1, wherein the pellets of fibre reinforced polypropylene composition ii)a) comprise 15-70% by total weight of the fibre reinforced polypropylene composition of fibres.

6. Mass transit vehicle component according to claim 1, wherein the pellets of a flame retardant fibre reinforced polypropylene composition iii) comprise
35-80% by total weight of the composition of polypropylene with optional additives
10-40% by total weight of the composition of fibres, and/or
10-35% by total weight of the composition of a flame retardant composition.

7. Mass transit vehicle component according to claim 1, wherein said fibres are selected from the group consisting of glass fibres, basalt fibres, wollastonite fibres, ceramic fibres, slag wool fibres, stone wool fibres, and processed mineral fibres from mineral wool.

8. Mass transit vehicle component according to claim 1, wherein said mass transit vehicle is selected from the group consisting of trains, trams, subways, light rails, monorails, aircrafts, helicopters, buses, trolleys, ferries, and cable cars.

9. Mass transit vehicle component according to claim 1, wherein said component is in the form of a panel, a laminate, a multilayer, a foam, or a honeycomb.

10. Mass transit vehicle component according to claim 1, wherein said component is one or more selected from the group consisting of not an automotive part, access panels, access doors, air flow regulator, baggage storage doors, display panels, display units, door handles, door pulls, enclosures for electronic devices, food carts, food trays, grilles, handles, magazine racks, seat components, partitions, refrigerator doors, seat backs, side walls, tray tables, trim panels, interior vertical surfaces, side walls, front walls, end-walls, partitions, room dividers, flaps, boxes, hoods, louvres, interior doors, linings for internal and external doors, window insulations, kitchen interior surfaces, interior horizontal surfaces, ceiling panelling, luggage racks, luggage containers, panelling and surfaces of driver's desk, interior surfaces of gangways, window frames, (folding) tables, air ducts, and devices for passenger information.

11. Mass transit vehicle component according to claim 1, wherein said component exhibits one or more selected from
(A) a smoke density after four minutes (Ds-4) of 300 or less as measured according to ISO 5659-2 on a 3 mm thick plaque at 50 kW/m²;
(B) an integral of the smoke density as a function of time up to 4 minutes (VOF4) of 400 or less as measured according to ISO 5659-2 on a 3 mm thick plaque at 50 kW/m²;
(C) a maximum average heat release (MAHRE) of 90 kW/m² or less as measured according to ISO 5660-1 of a 3 mm thick plaque at 50 kW/m²; and
(D) a critical heat flux at extinguishment (CFE) of 20 kW/m² or more as measured according to ISO 5658-2 on a 3 mm thick plaque.

12. Mass transit vehicle component according to claim 1, wherein said component exhibits one or more selected from
(1) a tensile modulus as measured according to ISO 527 in flow direction of 2500-8500 MPa;
(2) a tensile modulus as measured according to ISO 527 in crossflow direction of 1300-3800 MPa;
(3) an elongation at break as measured according to ISO 527 in flow direction of 0.5-1.8%;
(4) an elongation at break as measured according to ISO 527 in crossflow direction of 0.8-2.1%;
(5) a flexural modulus as measured according to ISO 178 in flow direction of 4600-7100 MPa; and
(6) a flexural modulus as measured according to ISO 178 in crossflow direction of 1400-2500 MPa.

13. Mass transit vehicle component according to claim 1, further comprising a cap layer comprising polypropylene.

14. Mass transit vehicle component according to claim 13,
wherein said component exhibits one or more selected from (1) a tensile modulus as measured according to ISO 527 in flow direction of 2000-3500 MPa;
(2) a tensile modulus as measured according to ISO 527 in crossflow direction of 1400-2200 MPa;
(3) an elongation at break as measured according to ISO 527 in flow direction of 0.9-2.7%;
(4) an elongation at break as measured according to ISO 527 in crossflow direction of 1.9-2.7%;
(5) a flexural modulus as measured according to ISO 178 in flow direction of 2200-3500 MPa; and
(6) a flexural modulus as measured according to ISO 178 in crossflow direction of 1000-1700 MPa.

15. Method for preparing a component for a mass transit vehicle with
a smoke density after four minutes (Ds-4) of 300 or less as measured according to ISO 5659-2 on a 3 mm thick plaque at 50 kW/m²; and/or
a maximum average heat release (MAHRE) of 90 kW/m² or less as measured according to ISO 5660-1 of a 3 mm thick plaque at 50 kW/m², preferably 89 kW/m² or less,
said method comprising moulding and/or extruding a component from a pellet or moulding composition as defined in claim 1.
